(19) United States
(12) Patent Application Publication
(10) Pub. No.: US 2007/0280215 A1
(43) Pub. Date: Dec. 6, 2007

(54) Method and apparatus for providing a click-to-talk service for advertisements

(76) Inventors: Mazin Gilbert, Warren, NJ (US); Narendra K. Gupta, Dayton, NJ (US); Benjamin J. Stern, Morris Township, NJ (US)

Correspondence Address: AT&T CORP., ROOM 2A207, ONE AT&T WAY, BEDMINSTER, NJ, 07921, US

(21) Appl. No.: 11/444,882

(22) Filed: May 31, 2006

(51) Int. Cl. H04L 12/66

(52) U.S. Cl. 370/356

(57) ABSTRACT

A method and apparatus for providing a click-to-talk service for advertisements carried over packet networks such as digital cable networks, Voice over Internet Protocol (VoIP) and Service over Internet Protocol (SoIP) networks are disclosed. For example, an enterprise customer subscribes to a service with a service provider that provides a click-to-talk feature with its advertisements on television channels. In one embodiment, the network service provider obtains meta-information from a video content and transmits the meta-information and the video content to a set-top box. The network service provider also enables consumers while viewing the advertisements to click on their remote control to initiate a call to talk to the advertising enterprise entity. Thus, when the consumer clicks-to-talk to the enterprise entity, the network service provider enables the consumer to reach the enterprise entity immediately.

The present invention relates generally to communication networks and, more particularly, to a method for providing a click-to-talk capability on advertisements that are transmitted over packet networks such as digital cable networks, Voice over Internet Protocol (VoIP) and Service over Internet Protocol (SoIP) networks, and the like.

### BACKGROUND OF THE INVENTION

The Internet has emerged as a critical communication infrastructure, carrying traffic for a wide range of applications. Internet services such as VoIP and SoIP are becoming ubiquitous and more and more enterprises and consumers are utilizing these networks to obtain a variety of services such as voice, data and video. The Internet based services offer the consumers much greater flexibility and control. For example, Voice over Internet Protocol (VoIP) service allows telephony users to obtain a feature rich service at a lower cost. In another example, video services can be delivered to consumers via broadcast channels. Thus, the consumer can receive multiple channels and tune to a specific channel for viewing. The broadcast media often contains advertisements from various enterprises. However, enterprises face several challenges in using the television media for marketing. For example, upon viewing the advertisements, consumers are not inclined to immediately interrupt their current viewing of the media content. If the consumers are actually interested in the products or services disclosed in the advertisements, the consumers will often contact the enterprise at a later time. This delayed behavior may reduce the overall effectiveness of the advertisements because the viewers may forget the information necessary to contact the enterprise or the viewers may simply forget that he or she was interested in the products or services. Furthermore, by the time the interaction between the enterprise and the viewer occurs, the viewer may not even recall the channel or program he/she was watching while the advertisement was being played, thereby limiting the enterprise's ability to gauge the effectiveness of its advertising efforts.

Therefore, there is a need for a method and apparatus that provide click-to-talk on advertisements.

### SUMMARY OF THE INVENTION

In one embodiment, the present invention discloses a method and apparatus for providing click-to-talk on advertisements, e.g., television advertisements, over packet networks such as digital cable networks, Voice over Internet Protocol (VoIP) and Service over Internet Protocol (SoIP) networks. For example, an enterprise customer subscribes to a service with a service provider that provides a click-to-talk feature with its advertisements on television channels. In one embodiment, the network service provider obtains meta-information from a video content and transmits the meta-information and the video content to a set-top box. In one embodiment, the video content comprises both a plurality of programs and a plurality of advertisements. The network service provider also enables consumers while viewing the advertisements to click on their remote control to initiate a call to talk to the advertising enterprise entity. Thus, when the consumer clicks-to-talk to the enterprise entity, the network service provider enables the consumer to reach the enterprise entity immediately.

In one embodiment, the service provider may also gather data regarding the channel, website, program, and the like that the viewer was watching when he/she clicked-to-talk. The information can then be forwarded to the enterprise customer of the service provider. Thus, the enterprise customer may utilize the data to determine the effectiveness of the advertisements on various programs and to improve marketing plans.

In one embodiment, the network service provider that forwarded the advertisements may not be providing telephony services to the consumer. In that case, the set-top box enables the consumer to interact with the enterprise customer via a second service provider, e.g., a telephony service provider, and at the same time sends the channel and program information back to the network service provider for data collection purposes.

### BRIEF DESCRIPTION OF THE DRAWINGS

The teaching of the present invention can be readily understood by considering the following detailed description in conjunction with the accompanying drawings, in which:

FIG. 1 illustrates an exemplary Voice over Internet Protocol (VoIP) network related to the present invention;

FIG. 2 illustrates an exemplary Service over Internet Protocol (SoIP) network related to the present invention;

FIG. 3 illustrates an exemplary network with one embodiment of the invention for providing click-to-talk on TV ads;

FIG. 4 illustrates a flowchart of the method for providing click-to-talk on TV ads;

FIG. 5 illustrates a flowchart of the method for a set-top box; and

FIG. 6 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing a service, e.g., a click-to-talk service, for advertisements, e.g., Television (TV) advertisements, over packet networks such as digital cable networks, Voice over Internet Protocol (VoIP), or Service over Internet Protocol (SoIP) networks and the like. Although the present invention is discussed below in the context of services in VoIP and SoIP networks, the present invention is not so limited. Namely, the present invention can be applied for other networks such as cellular networks, digital cable networks, and the like.

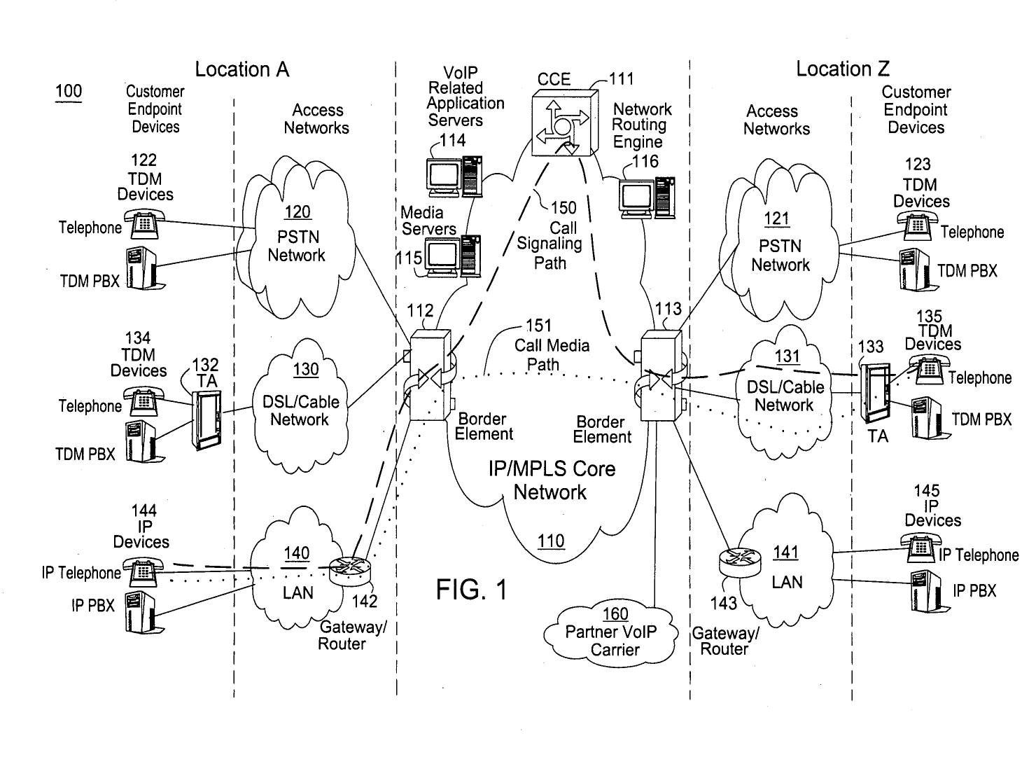

To better understand the present invention, FIG. 1 illustrates communication architecture 100 having an example network, e.g., a packet network such as a VoIP network related to the present invention. Exemplary packet networks include internet protocol (IP) networks, asynchronous transfer mode (ATM) networks, frame-relay networks, digital cable networks and the like. An IP network is broadly defined as a network that uses Internet Protocol to exchange data packets. Thus, a VoIP network or a SoIP network is considered an IP network.

In one embodiment, the VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. The present invention is described below in the context of an illustrative VoIP network. Thus, the present invention should not be interpreted to be limited by this particular illustrative architecture.

The customer endpoint devices can be either Time Division Multiplexing (TDM) based or IP based. TDM based customer endpoint devices 122, 123, 134, and 135 typically comprise of TDM phones or Private Branch Exchange (PBX). IP based customer endpoint devices 144 and 145 typically comprise IP phones or IP PBX. The Terminal Adaptors (TA) 132 and 133 are used to provide necessary inter-working functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices.

The core VoIP infrastructure comprises of several key VoIP components, such the Border Element (BE) 112 and 113, the Call Control Element (CCE) 111, VoIP related Application Servers (AS) 114, and Media Server (MS) 115. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller or a softswitch and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related Application Servers (AS) in order to complete a call that require certain service specific features, e.g. translation of an E.164 voice network address into an IP address.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

In order to illustrate how the different components operate to support a VoIP call, the following call scenario is used to illustrate how a VoIP call is setup between two customer endpoints. A customer using IP device 144 at location A places a call to another customer at location Z using TDM device 135. During the call setup, a setup signaling message is sent from IP device 144, through the LAN 140, the VoIP Gateway/Router 142, and the associated packet based access network, to BE 112. BE 112 will then send a setup signaling message, such as a SIP-INVITE message if SIP is used, to CCE 111. CCE 111 looks at the called party information and queries the necessary VoIP service related application server 114 to obtain the information to complete this call. In one embodiment, the Application Server (AS) functions as a SIP back-to-back user agent. If BE 113 needs to be involved in completing the call; CCE 111 sends another call setup message, such as a SIP-INVITE message if SIP is used, to BE 113. Upon receiving the call setup message, BE 113 forwards the call setup message, via broadband network 131, to TA 133. TA 133 then identifies the appropriate TDM device 135 and rings that device. Once the called party accepts the call at location Z, a call acknowledgement signaling message, such as a SIP 200 OK response message if SIP is used, is sent in the reverse direction back to the CCE 111. After the CCE 111 receives the call acknowledgement message, it will then send a call acknowledgement signaling message, such as a SIP 200 OK response message if SIP is used, toward the calling party. In addition, the CCE 111 also provides the necessary information of the call to both BE 112 and BE 113 so that the call data exchange can proceed directly between BE 112 and BE 113. The call signaling path 150 and the call media path 151 are illustratively shown in FIG. 1. Note that the call signaling path and the call media path are different because once a call has been setup up between two endpoints, the CCE 111 does not need to be in the data path for actual direct data exchange.

Media Servers (MS) 115 are special servers that typically handle and terminate media streams, and to provide services such as announcements, bridges, transcoding, and Interactive Voice Response (IVR) messages for VoIP service applications.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

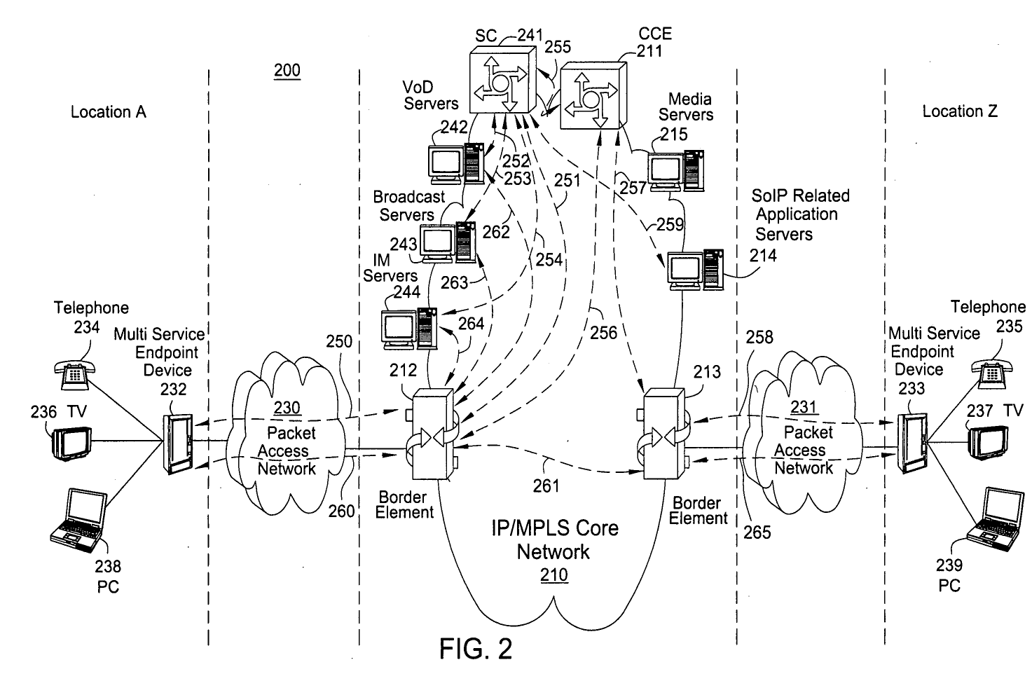

The network shown in FIG. 1 can be extended to become a SoIP network that supports multi-service applications including, but not limited to, video services. FIG. 2 illustrates communications architecture 200 having an example network, e.g., a packet network such as a SoIP network related to the present invention. A SoIP network supports multi-service applications including voice, data, and video services. In one embodiment, a SoIP network that supports video services is described below. In this SoIP network, voice services supported include, but are not limited to, VoIP services; data services supported include, but are not limited to, Instant Messaging (IM), electronic mail (email), internet access services, or any other IP based applications; and video services include, but are not limited to, Video on Demand (VoD), broadcast video, streaming video, and video conferencing services.

A SoIP network that supports video services comprises an intelligent multi-service endpoint device connected via packet access networks to a service provider's SoIP core infrastructure employing Internet Protocol (IP) and/or Multi-Protocol Label Switching (MPLS) Protocols. Broadly defined, a SoIP network is a network that is capable of carrying voice, video, and data signals as packetized data over an IP network. The present invention is described below in the context of an illustrative SoIP network that supports video services. Thus, this particular illustrative architecture should not be interpreted as limiting the present invention.

Multi-service endpoint devices 232 and 233 are IP based intelligent endpoint devices supporting voice, video, and data applications. Multi-service endpoint devices 232 and 233 are signaling endpoints of application sessions, e.g. a VoIP session endpoint, an instant messaging endpoint, or a video session endpoint. In one embodiment, a multi-service endpoint device is a standalone device that can be connected to home electronic appliances such as, but is not limited to, telephone 234 and 235, TV 236 and 237, or Personal Computer (PC) 238 and 239. In another embodiment, a multi-service endpoint device can be integrated with a TV, a PC, or any home appliances with a display.

The access networks are packet based. Packet based access networks 230 and 231 use, but are not limited to, Frame Relay, ATM, Ethernet, IP, DSL or Cable broadband access network technologies to interconnect a multi-service endpoint device to a SoIP network that supports video, data and voice services.

The core SoIP infrastructure that supports video services comprises of several key components, such the Border Element (BE) 212 and 213, the Call Control Element (CCE) 211, SoIP related Application Servers (AS) 214, Media Servers (MS) 215, Session Controller (SC) 241, Video on Demand (VoD) Servers 242, Broadcast Servers (242), and Instant Messaging (IM) Servers 243. A BE resides at the edge of the SoIP core infrastructure and interfaces with customers endpoints over various types of access networks. The functions supported by a BE include those supported by a BE as previously described in network 100 and FIG. 1. In addition, in a SoIP network that supports video services, a BE also serves as a gateway between a multi-service endpoint device used by a subscriber and the SoIP core network that supports video services. All application sessions initiated by a SoIP subscriber must gain entry to the SoIP core network via a BE. The functions supported by a CCE and a MS are the same as those previously described in network 100 and FIG. 1. A Session Controller (SC) resides within the SoIP infrastructure and is connected to the BEs using an IP based signaling protocol such as, but is not limited to, Session Initiation Protocol (SIP). A SC is responsible for setting up all application session requests, such as VoIP call requests, video session requests, or data session requests, originated by a customer within the network and interacts with, if necessary, the appropriate SoIP related AS in order to complete an application session that requires certain service specific features originated by a customer. A SC also keeps track of all sessions initiated by a customer for session management and billing purposes. The functions supported by a SoIP related AS include those supported by a VoIP AS as previously described in network 100 and FIG. 1. In addition, a SoIP AS also supports all video specific application features. A VoD Server is responsible for supporting video on demand video session requests originated by a customer and sends the requested streaming video contents, such as a movie, to the customer. A broadcast server is responsible for supporting broadcast video sessions originated by a customer. The broadcast server also sends streaming broadcast video contents, such as TV channels, to the customer. The VoD Server and the Broadcast Server send streaming video contents to multi-service endpoint devices using compression technologies including, but are not limited to, Moving Picture Experts Group (MPEG) 2, MPEG 4, MPEG 7, MPEG 21. An IM Server is responsible for supporting IM applications involving multiple users. Instant Messaging is a form of electronic communication that involves immediate typed text correspondence between two or more users over the Internet who are online simultaneously. IM is a text-based computer conference over the Internet between two or more people who are online at the same time.

In order to illustrate how the different components in a SoIP network operate to support video services, the following scenarios are used to illustrate how voice, data, and video sessions are setup between the SoIP network and a customer endpoint. In one embodiment, a customer using a multi-service endpoint device 232 at location A places a VoD session request to the SoIP network that supports video services using TV 236. During the session initiation, a setup-signaling message is sent from multi-service endpoint device 232 to BE 212 using signaling path segment 250. BE 212 will then send a setup signaling message, such as a SIP-INVITE message if SIP is used, to SC 241 using signaling path segment 251. SC 241 processes the session requests and forwards the request to the appropriate server for further processing. In this case, the request is a VoD session; therefore, the request will be forwarded to VoD Server 242 using signaling path segment 252. SC 241 may interact with AS 214 using signaling path segment 259 to verify customer's subscription information or to retrieve video specific applications or data in order to complete the session request. Once the VoD session is verified, VoD Server 242 sends the requested VoD streaming contents to BE 212 using data path segment 262. BE 212 then forwards the requested VoD streaming contents to multi-service endpoint 232 using data path segment 260. Similarly, a customer at location Z using TV 237 connected to multi-service endpoint device 233 can request a VoD session via SC 241 with streaming VoD contents sent by VoD Server 242. Note that a VoD server may be placed closer to end users in a packet access network to serve multi-service endpoints in an alternative embodiment.

In another embodiment, a customer using multi-service endpoint device 232 at location A places a broadcast video session request to the SoIP network that supports video services using TV 236. During the session initiation, a setup-signaling message is sent from multi-service endpoint device 232 to BE 212 using signaling path segment 250. BE 212 will then send a setup signaling message, such as a SIP-INVITE message if SIP is used, to SC 241 using signaling path segment 251. SC 241 processes the session requests and forwards the request to the appropriate server for further processing. In this case, the request is a broadcast video session for a particular premium TV channel; therefore, the request will be forwarded to Broadcast Server 243 using signaling path segment 253. SC 241 may interact with AS 214 using signaling path segment 259 to verify customer's subscription information or to retrieve video specific applications or data in order to complete the session request. Once the broadcast session is verified, Broadcast Server 243 sends the requested broadcast video streaming contents to BE 212 using data path segment 263. BE 212 then forwards the requested broadcast video streaming contents to multi-service endpoint 232 using data path segment 260. Similarly, a customer at location Z using TV 237 connected to multi-service endpoint 233 can request a broadcast video session via SC 241 with streaming broadcast video contents sent by Broadcast Server 243. Note that a Broadcast server may be placed closer to end users in a packet access network to serve multi-service endpoints in an alternative embodiment.

In another embodiment, a customer using multi-service endpoint device 232 at location A places an IM session request to the video network using PC 238. During the session initiation, a setup signaling message is sent from multi-service endpoint device 232 to BE 212 using signaling path segment 250. BE 212 will then send a setup signaling message, including login and password information of the user, to SC 241 using signaling path segment 251. SC 241 processes the session requests and forwards the request to the appropriate server for further processing. In this case, the request to sign on an IM session; therefore, the request will be forwarded to IM Server 244 using signaling path segment 254. SC 241 may interact with AS 214 using signaling path segment 259 to verify customer's subscription information or to retrieve IM specific applications or data in order to complete the session request. Once the IM session is verified, IM Server 244 establishes the requested IM data path to multi-service endpoint 232 via BE 212 using data path comprising data path segments 260 and 264. Similarly, a customer at location A using TV 236 connected to multi-service endpoint 232 or a customer at location Z using PC 239 or TV 237 connected to multi-service endpoint 233 can request an IM session via SC 241 with IM functions provided by IM Server 244.

In another embodiment, a customer using multi-service endpoint device 232 at location A places a VoIP session request destined to multi-service endpoint device 233 via the SoIP network that supports video services using telephone 234. During the session initiation, a setup signaling message is sent from multi-service endpoint device 232 to BE 212 using signaling path segment 250. BE 212 will then send a setup signaling message, such as a SIP-INVITE message if SIP is used, to SC 241 using signaling path segment 251. SC 241 processes the session requests and forwards the request to the appropriate server for further processing. In this case, the request is a VoIP session for a call destined to a called party at location Z; therefore, the request will be forwarded to CCE 211 using signaling path segment 255. CCE may interact with AS 214 using signaling path segment 259 to verify customer's subscription information or to retrieve VoIP specific applications or data in order to complete the session request. The signaling flows to establish a VoIP call between multi-service endpoint device 232 and 233 is similar to those described previously in network 100 and FIG. 1. In one embodiment, the Application Server (AS) functions as a SIP back-to-back user agent. Since BE 213 needs to be involved in completing the call; CCE 211 sends another call setup message, such as a SIP-INVITE message if SIP is used, to BE 213 using signaling path segment 257. Upon receiving the call setup message, BE 213 forwards the call setup message, via packet access network 231 to multi-service endpoint device 233 using signaling path segment 258. The multi-service endpoint device 233 then identifies telephone 235 and rings that telephone. Once the called party accepts the call at location Z, a call acknowledgement signaling message, such as a SIP 200 OK response message if SIP is used, is sent in the reverse direction back to the CCE 211. After the CCE 211 receives the call acknowledgement message, it will then send a call acknowledgement signaling message, such as a SIP 200 OK response message if SIP is used, toward the calling party at location A using signaling path comprising signaling path segments 256 and 250 via BE 212. In addition, the CCE 211 also provides the necessary information of the call to BE 212 and BE 213 so that the call data exchange can proceed directly between BE 212 and BE 213. CCE 211 also provides the call completion status of a VoIP call to SC 241. The call media path comprising media path segment 260, 261, and 265 are illustratively shown in FIG. 2. Note that the call signaling path and the call media path are different because once a call has been setup up between two multi-service endpoint devices, SC 241 and CCE 211 don't need to be in the data path for actual direct data exchange.

As extremely high bandwidth access networks become more accessible to residential subscribers, the high bandwidth networks enable service providers to integrate voice, video, and data, thereby providing more convenience for customers and creating new service opportunities. For example, video services can be delivered to consumers via broadcast channels and/or direct video streaming over packet networks such as VoIP or SoIP infrastructures, digital cable networks, and the like. A customer is offered multiple channels or video sources, and selects a specific channel or source for viewing. The broadcast media or streaming media often contains advertisements from various enterprises. However, enterprises face several challenges in using the television media for marketing. For example, upon viewing the displayed advertisements, consumers are not inclined to immediately interrupt their current viewing of the media content. If the consumers are actually interested in the products or services disclosed in the advertisements, the consumers will often contact the enterprise at a later time. This delayed behavior may reduce the overall effectiveness of the advertisements because the viewers may forget the information necessary to contact the enterprise or the viewers may simply forget that he or she was interested in the products or services. Furthermore, by the time the interaction between the enterprise and the viewer occurs, the viewer may not even recall the channel or program he/she was watching while the advertisement was being played, thereby limiting the enterprise's ability to gauge the effectiveness of its advertising efforts. The consumer is also inconvenienced because he/she cannot easily reach the enterprise while the advertisement is playing without being required to take several steps, e.g. noting the contact address or phone number, making a phone call, sending email to the enterprise, etc. Therefore, there is a need for a method that provides click-to-talk on television advertisements.

The current invention discloses a method and apparatus for providing a click-to-talk service on advertisements, e.g., TV advertisements, carried over packet networks such as digital cable networks, VoIP or SoIP networks, and the like. In order to clearly illustrate the teachings of the current invention, the following networking terminologies will first be described:
A set-top box; and
Meta-information.

A set-top box is a device with input and output interfaces that enables a user to receive video. For example, the interfaces are deployed for interfacing with a TV or a display, a user, a service provider's network, and/or other home-network components. In one embodiment, the set-top box may contain a tuner for channel selection by the user, a display for indicating the selected channel to the user, an interface for changing the channel (up/down buttons), a processor for controlling the various functions and a data modem for interacting with the service provider. If the set-top box has the capability to communicate with a remote control, then it will also have infrared sensors to receive user input via the remote control. In one embodiment, the set-top box may keep track of the channel, program, time, and the like that the viewer is watching and is tasked with receiving the advertisements and the meta-information as defined below for the programs from a service provider.

Meta-information refers to definition or description of information. For example, metadata refers to description of data. Meta-language refers to description of language. In one embodiment, television programs may contain meta-information provided by the content provider or media network. The meta-information can be used for ease of programming. For example, a network service provider can determine when an advertisement should appear from the meta-information. The network service provider may extract program information from meta-information included in programs. An example of meta information is provided below:
<Title> Today Show With Jane Doe</title>
<MediaNetworkAffiliation>AAA Affiliate</MediaNetworkAffiliation>
<MediaStationName>WAAA</MediaStationName>

The current invention enables a service provider to offer a click-to-talk service on displayed advertisements. For example, when a viewer invokes the click-to-talk service via the remote control, the set-top box enables the viewer to talk to an enterprise associated with the current advertisement that is currently being displayed. For example, if a viewer is watching an advertisement for an AT&T service and clicks the click-to-talk interface (button, etc), the network service provider initiates a call, thereby enabling the viewer to speak to an AT&T agent inquiring about the AT&T service that was the subject of the recently viewed advertisement. If the network service provider is also capable of providing the telephony service, then the set-top box forwards the call request to the network service provider. If the network service provider is not. also capable of providing the telephony service, then the set-top box forwards the call request to another service provider's network (e.g., another carrier). For example, the set-top box may be enabled to provide the click-to-talk feature via the customer's cellular telephone. In that case, the set-top box may activate a telephone call from the viewer's cellular telephone to the enterprise customer.

In one embodiment, the meta-information associated with the program that the viewer was watching when the advertisement was presented to the viewer is also forwarded back to the network service provider. In turn, the enterprise customer of the service provider may use the returned meta-information for evaluating its marketing strategies. For example, the returned meta-information may indicate to the enterprise customer that the advertisements are effective when displayed with some programs and/or channels, while the advertisements are ineffective when displayed with some other programs and/or other channels and so on.

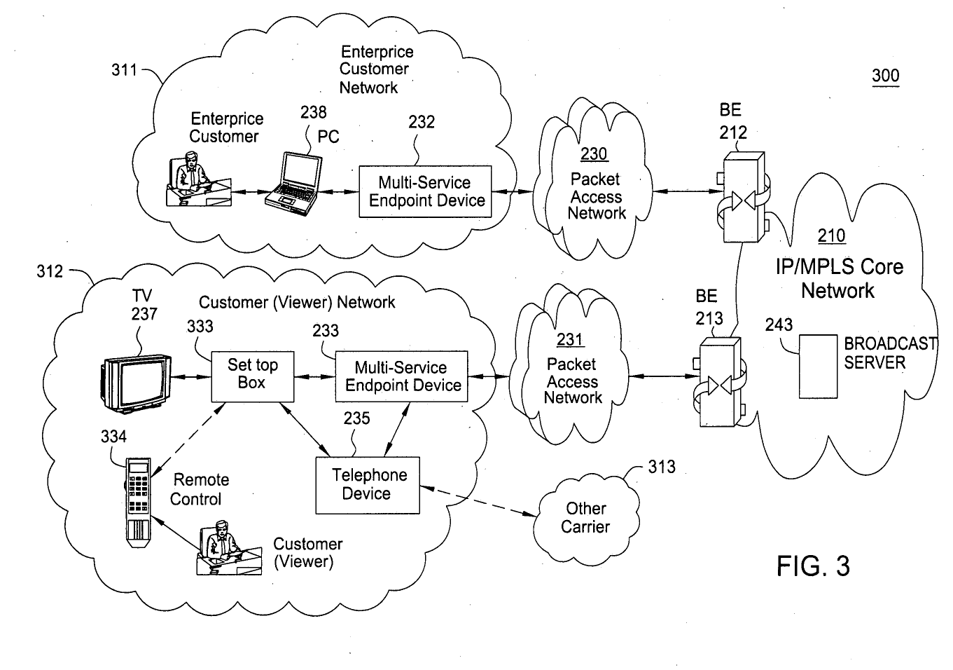

FIG. 3 illustrates an exemplary network 300 of the present invention to provide a click-to-talk service for advertisements, e.g., TV advertisements. For example, an enterprise customer network 311 may contain a computer 238 connected to a multi-service endpoint device 232. The multi-service endpoint device is connected to an access network 230. The access network 230 is connected to a network service provider's IP/MPLS core network 210 via a border element 212. In one embodiment, the enterprise customer uses the computer 238 to obtain services from the network service provider.

The consumer (or viewer) may also have a network 312 that may contain a TV or display 237, a set-top box 333, a remote control for the set-top box 334, a telephony device 235 and a multi-service endpoint device 233. In operation, the consumer uses the set-top box 333, the remote control 334 and the TV 237 to access broadcast channels. The set-top box 333 is connected to the multi-service endpoint device 233. The multi-service endpoint device is connected to a packet access network 231. The access network 231 accesses the IP/MPLS core network 210 via a border element 213. The telephony device 235 is capable of communicating with the set-top box 333 to enable the set-top box to utilize the telephony device for supporting the click-to-talk feature. In one embodiment, the telephone device 235 is connected to the multi-service endpoint device 233 to enable the viewer to talk to the enterprise customer. In another embodiment, the telephone device 235 is connected to another carrier's network 313.

In one embodiment, the service provider utilizes a broadcast server 243 to provide the click-to-talk service for advertisements, e.g., TV advertisements. For example, the broadcast server 243 obtains the meta-information associated with a program and/or channel and transmits the meta-information to the set-top box 333 along with the advertisements. In one embodiment, the meta-information is not displayed to the viewer. When the viewer clicks the remote control 334 to initiate a call request for talking to the enterprise customer associated with a particular displayed advertisement, the set-top box initiates a call request via the telephony device 235 and gathers information regarding the time, program and/or channel that the viewer was watching when he/she activated the clicked to talk service. The voice packets for the call may be transmitted over the IP/MPLS core network 210 or another carrier's network 313 depending on the carrier that the viewer is using for telephony services. In one embodiment, the enterprise customer may then utilize the program information that the viewer was watching to improve marketing strategies by analyzing the effectiveness of various advertisements.

Those skilled in the art will realize that the functions provided in the set-top box, remote control, telephony device, multi-service end-point device and broadcast server may be provided on multiple servers or integrated or combined in any of the disclosed devices. Furthermore, the device may be located at the customer premise or at the service provider's network.

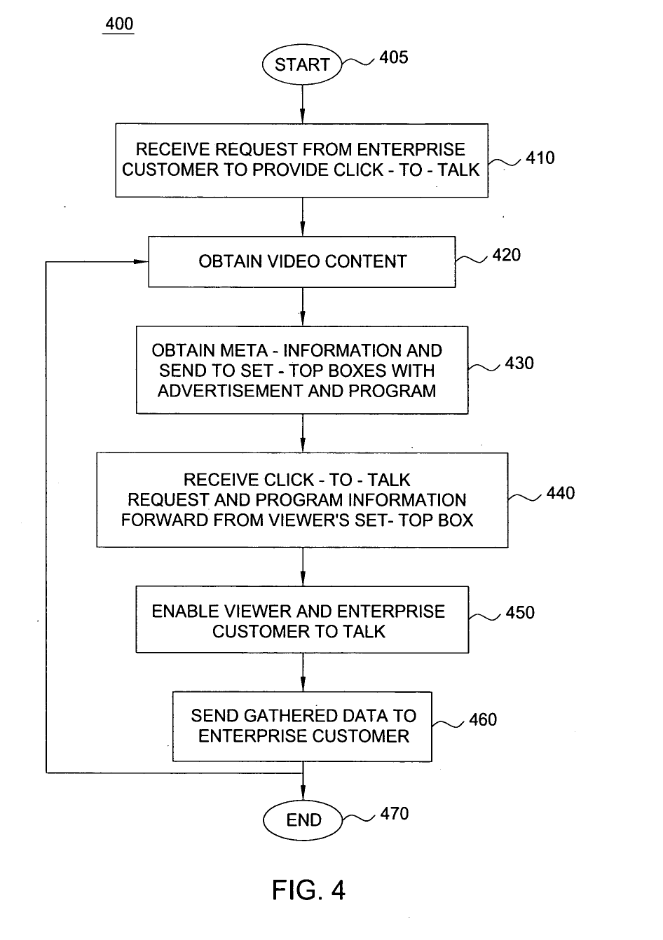

FIG. 4 illustrates a flowchart of a method 400 for providing a click-to-talk service for advertisements. In one embodiment, the network service provider enables an enterprise customer to subscribe to the click-to-talk service for its TV advertisements. In turn, the service provider also enables the consumer (or viewer) to reach the enterprise customer by clicking on a remote control while the enterprise customer's advertisement is playing.

Method 400 starts in step 405 and proceeds to step 410. In step 410, method 400 receives a request from an enterprise customer to provide a click-to-talk service for its TV advertisements. For example, the enterprise customer may send a request via a web site and orders the service from a service provider. The enterprise customer may provide or identify the meta-information with the subscription or may request that the service provider mine the information from broadcast or streaming programs.

In step 420, method 400 obtains the video content. For example, the service provider may obtain media content from various broadcast network affiliates or various servers providing direct video streaming. Note that the content for the various channels may be obtained from various media sources (e.g., content providers). The present invention is not limited by how these content are obtained.

In step 430, method 400 obtains the meta-information and sends the meta-information to the set-top boxes with the advertisements. For example, the meta-information for the programs can be provided, e.g., as side information from the content provider. Similarly, the meta-information for the advertisements (e.g., phone number, email address, toll free number and the like) can also be provided as side information from the content provider. Alternatively, the meta-information may also be obtained directly from the enterprise customer, e.g., codes that can be embedded into the advertisements that can be associated with a particular enterprise customer. Meta information can also be added by the network service provider, using their own list of advertisers, phone numbers, and so on.

In one embodiment, the meta-information, the program and advertisement are sent to the set-top box in step 430. The set-top box receives the meta-information, the programs and advertisements but plays only the advertisements and the programs. In one embodiment, the meta-information is not displayed to the viewer.

In step 440, method 400 receives a click-to-talk request and/or program information forwarded from a viewer's set-top box. Program information may include but is not limited to a time, a channel, a show or program when the click-to-talk feature was activated by the viewer. For example, when a viewer activates the clicks-to-talk feature, the set-top box enables a call request to the enterprise customer to occur and records the time, program, channel, and the like that the viewer was watching when he/she activated the clicked-to-talk feature. The set-top box then gathers the meta-information and forwards it to the network service provider.

In step 450, method 400 enables the viewer and the enterprise customer to talk or to interact, e.g., establishing a communication channel. For example, the service provider is also providing voice services to the viewer and therefore receives the click-to-talk request from the viewer. Upon receipt of the call request, the service provider will initiate and establish a call connection (e.g., broadly defined as a communication channel) to the enterprise customer on behalf of the viewer.

In another embodiment, if the network service provider does not provide telephony service, then the call request is forwarded to another carrier. Therefore, in one embodiment, the service provider only receives program meta-information but is not tasked with processing the call request to the enterprise customer. It should be noted that in one embodiment a server may still possess the capability to dial the viewer and the enterprise customer to effect a call connection even if the service provider is currently not providing telephony service to the viewer.

In step 460, method 400 sends the gathered data (e.g., the meta-information associated with the programs) to the enterprise customer. For example, the service provider may have counters for counting the number of viewers during a particular program who wanted to call the enterprise customer based on a particular advertisement displayed within a particular program or on a particular channel and the like. The service provider and the enterprise customer determine the format and content of the data to be gathered and forwarded back to the enterprise customer. The method then ends in step 470 or returns to step 420 to receive more content.

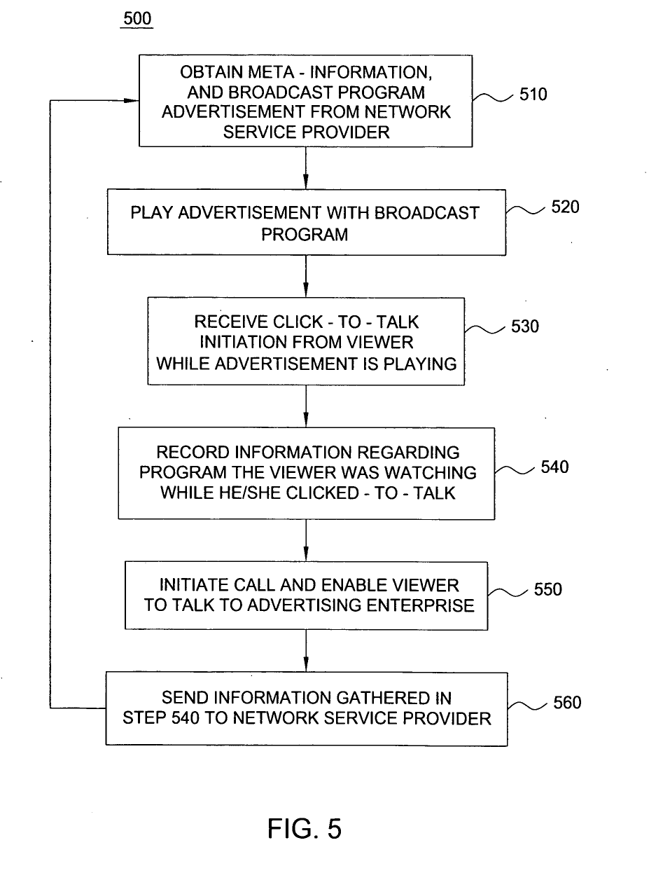

FIG. 5 illustrates a flowchart of a method 500 for providing a click-to-talk service for displayed advertisements via a customer premise equipment, e.g., a set-top box. In step 510, method 500 obtains meta-information, video programs and advertisements from the network service provider. In one embodiment, the network service provider composes the meta-information from programs and/or advertisements and sends the meta-information with the advertisements and video programs.

In step 520, method 500 plays the advertisement with the video program(s). In one embodiment, the meta-information is not displayed to the viewer.

In step 530, method 500 receives a click-to-talk initiation from the viewer (e.g., broadly defined as receiving a request from the viewer to contact the enterprise associated with a particular advertisement). For example, the viewer presses a specific button on a remote control or a button on the set-top box. Note that the viewer initiates the click-to-talk service while an advertisement is playing.

In step 540, method 500 records information regarding the program that the viewer was watching while he/she initiated the clicked-to-talk service.

In step 550, method 500 initiates the call and enables the viewer to talk to the advertising enterprise customer. For example, method 500 causes a call request to be forwarded to a telephony service provider directed to the enterprise customer, e.g., using meta-information associated with a particular advertisement.

In step 560, method 500 sends the meta-information gathered in step 540 to the network service provider. The network service provider may then forward the returned meta-information to the enterprise customer associated with the advertisement that caused the viewer to initiate the click-to-talk service.

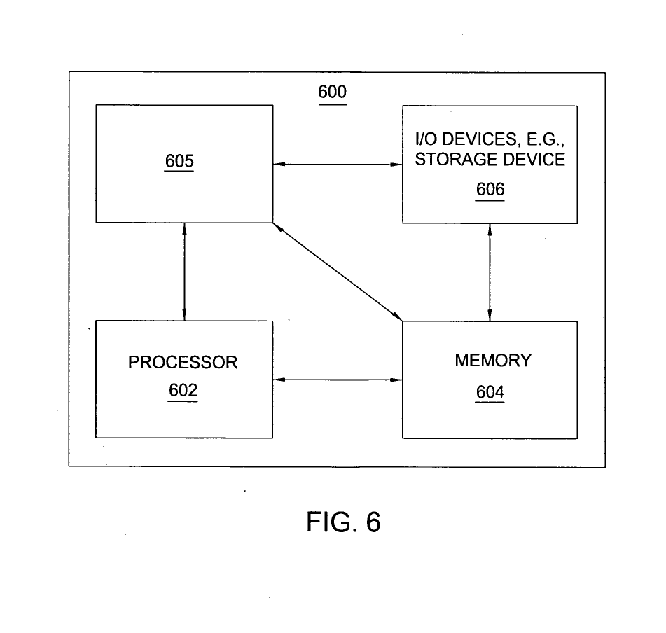

FIG. 6 depicts a high-level block diagram of a general-purpose computer suitable for use in performing the functions described herein. As depicted in FIG. 6, the system 600 comprises a processor element 602 (e.g., a CPU), a memory 604, e.g., random access memory (RAM) and/or read only memory (ROM), a module 605 for providing a click-to-talk service for advertisements, and various input/output devices 606 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, alarm interfaces, power relays and the like)).

It should be noted that the present invention can be implemented in software and/or in a combination of software and hardware, e.g., using application specific integrated circuits (ASIC), a general-purpose computer or any other hardware equivalents. In one embodiment, the present module or process 605 for providing the click-to-talk service for advertisements can be loaded into memory 604 and executed by processor 602 to implement the functions as discussed above. As such, the present method 605 for providing a click-to-talk service for advertisements (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing a service associated with an advertisement in a communication network, comprising:
obtaining meta-information from video content, where said video content comprises: at least one program and at least one advertisement;
sending said meta-information and said video content to at least one viewer; and
receiving a request from said at least one viewer while said at least one advertisement is being displayed to contact an enterprise customer associated with said at least one advertisement.

2. The method of claim 1, wherein said communication network is a digital cable network, a Voice over Internet Protocol (VoIP) network or a Service over Internet Protocol (SoIP) network.

3. The method of claim 1, further comprising:
receiving meta-information from said at least one viewer relating to said at least one program or at least one channel when said request was generated.

4. The method of claim 3, further comprising:
forwarding said meta-information received from said at least one viewer to said enterprise customer.

5. The method of claim 1, wherein said meta-information and said video content are sent to a customer premise equipment of said at least one viewer.

6. The method of claim 5, wherein said customer premise equipment is a set-top box.

7. The method of claim 1, further comprising:
processing said request to establish a communication channel between said at least one viewer and said enterprise customer.

8. A system for providing a service associated with an advertisement in a communication network, comprising:
means for obtaining meta-information from video content, where said video content comprises: at least one program and at least one advertisement;
means for sending said meta-information and said video content to at least one viewer; and
means for receiving a request from said at least one viewer while said at least one advertisement is being displayed to contact an enterprise customer associated with said at least one advertisement.

9. The system of claim 8, wherein said communication network is a digital cable network, a Voice over Internet Protocol (VoIP) network or a Service over Internet Protocol (SoIP) network.

10. The system of claim 8, further comprising:
means for receiving meta-information from said at least one viewer relating to said at least one program or at least one channel when said request was generated.

11. The system of claim 10, further comprising:
means for forwarding said meta-information received from said at least one viewer to said enterprise customer.

12. The system of claim 8, wherein said meta-information and said video content are sent to a customer premise equipment of said at least one viewer.

13. The system of claim 12, wherein said customer premise equipment is a set-top box.

14. The system of claim 8, further comprising:
means for processing said request to establish a communication channel between said at least one viewer and said enterprise customer.

15. A method for providing a service associated with an advertisement in a communication network, comprising:
receiving meta-information and video content destined to at least one viewer, where said video content comprises: at least one program and at least one advertisement;
receiving a request from said at least one viewer while said at least one advertisement is being displayed to contact an enterprise customer associated with said at least one advertisement; and
forwarding said request to a first service provider for establishing a communication channel between said at least one viewer and said enterprise customer.

16. The method of claim 15, wherein said communication network is a digital cable network, a Voice over Internet Protocol (VoIP) network or a Service over Internet Protocol (SoIP) network.

17. The method of claim 15, further comprising:
recording meta-information relating to said at least one program or at least one channel when said request was generated.

18. The method of claim 17, further comprising:
forwarding said recorded meta-information to a second service provider that provided said video content.

19. The method of claim 17, wherein said first service provider and said second service provider are different service providers or a same service provider.

20. The method of claim 15, wherein said meta-information and video content are received by a customer premise equipment.
